(19) United States
(12) Patent Application Publication
(10) Pub. No.: US 2010/0300349 A1
(43) Pub. Date: Dec. 2, 2010

(54) Apparatus for identifying a pipe at a remote location

(76) Inventors: Matt Osmun, Redding, CT (US); Stephen King, Westport, CT (US)

Correspondence Address: JAMES F MCLAUGHLIN, 11 Ashwood Lane, Brookfield, CT, 06804, US

(21) Appl. No.: 12/791,850

(22) Filed: Jun. 1, 2010

Related U.S. Application Data
(60) Provisional application No. 61/182,760, filed on Jun. 1, 2009.

(51) Int. Cl. G01D 21/00

(52) U.S. Cl. 116/209

(57) ABSTRACT

A remote pipe identifier system is implemented by a source vibrational transmitter mechanically attached to a selected pipe at one location which transmits vibrations into the source pipe. A technician is able to detect the vibrations in a remote location by using a sensitive detector and thus successfully identify the pipe of interest in his work quickly and without any invasive technique.

### CROSS REFERENCES TO RELATED APPLICATIONS

This non-provisional patent application claims a priority benefit to U.S. Provisional Application No. 61,182,760 entitled “Apparatus for identifying a pipe at a remote location” filed in the United States Patent and Trademark Office on Jun. 1, 2009 by a common Inventor to this instant application, Matt Osmun. Further the above named Provisional Application is hereby incorporated by reference.

### STATEMENT REGARDING FEDERALLY SPONSORED RESEARCH

Not Applicable

### REFERENCE TO APPENDIX

Not Applicable

### BACKGROUND OF THE INVENTION

The apparatus for identifying a pipe at a remote location is a portable tool consisting of a housing, a motor having a motor output member, a multi-speed transmission, a gear driven member, a reciprocating pin, a permanently installed rechargeable battery, a connecting strap, an on/off switch and a remote on/off function. The switching mechanism provides at least three operating speeds and activates the motor output member, which is located in the housing. The transmission is configured to receive a rotary input from the motor output member and to produce a rotary output that is transmitted to the gear driven member connected to the reciprocating pin. When the transmission is activated it drives the gear member which slides the pin in a reciprocating fashion through a hole in one end of the housing. The gear driven member moves the pin between a first end position, in which the pin is fully retracted within the housing, and a second end position, in which the pin protrudes from the housing. The Tapper is particularly compact, lightweight and durable.

The Tapper is a portable plumbing tool primarily intended to assist a technician in locating and isolating a specific plumbing pipe. The housing attaches to the pipe with the connecting strap and, when the switch is activated, the reciprocating pin extends through the housing and repeatedly strikes the pipe. The pin striking the pipe creates a “tapping” effect that causes an vibrational wave to travel up and down the pipe run and allows the technician to trace, locate and isolate that specific pipe in a location other than where the Tapper is connected.

A remote control device may be used in conjunction with the Tapper to control its operation. Further the remote control device also includes a sensitive detector which may be touched to varying pipes in remote locations and to ‘listen’ and determine which of the pipes is being ‘tapped’.

### FIELD OF THE INVENTION

This invention relates to conduit location devices and in particular to a plumbing pipe identifier for identifying a selected pipe among other nearby pipes in residential or commercial applications.

### DESCRIPTION OF PRIOR ART

No prior inventions using the embodiments disclosed herein are known to the Inventors.

### BRIEF SUMMARY OF THE INVENTION

The invention comprises a vibrational transmitter which is mechanically attached to a known pipe or conduit. The vibrations are conducted along the selected pipe to any remote locations the pipe travels to. The service technician is able to identify by listening with the naked ear or by using a sensitive detector which pipe among several is the pipe of interest at the remote location.

In a further embodiment, the vibrations can be calibrated to determine acoustic parameters or defects of the pipe network.

A further embodiment is accomplished by encoding messages in the transmitted vibrations to allow communications for rescue work or other worthy purposes. In this embodiment, communication (or vibrations) may be transmitted and received by both ends of the system.

### BRIEF DESCRIPTION OF THE DRAWINGS

FIG. 1. shows a side perspective view of the pipe tapper invention.

FIG. 2 shows a remote control embodiment of the invention.

FIG. 3 shows a remote control unit with a detector.

FIG. 4 shows the remote control unit transmitter and receiver.

FIG. 5 shows the internal power train of the pipe tapper invention.

FIG. 6 shows the linkage of the drive wheel and tapping pin.

### DETAILED DESCRIPTION OF THE EMBODIMENT

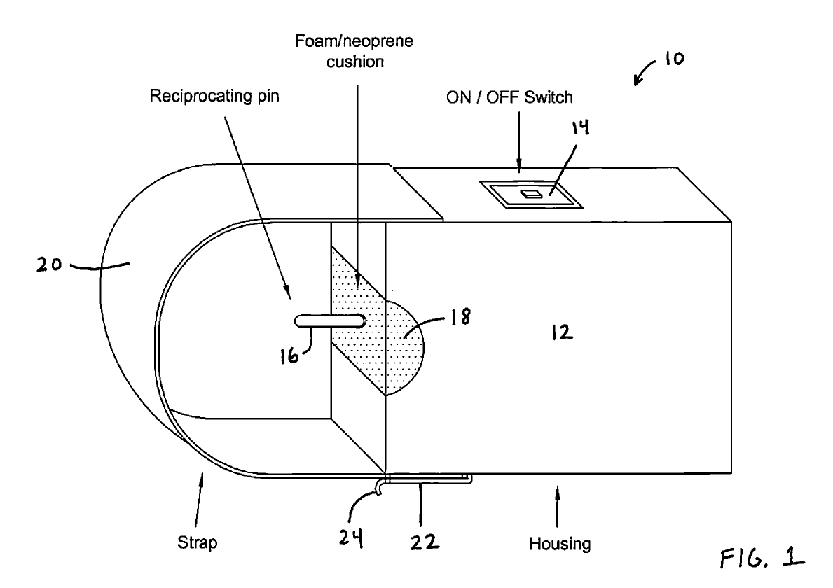

Now referring to FIG. 1 a first embodiment of the pipe tapper 10 is shown. It consists of a housing 12 having an external power switch 14. A reciprocating pin 16 protrudes from a foam pad 18 embedded in the side of the housing 12. The pin 16 further protrudes into a space surrounded by a strap 20. The strap 20 is used to secure the tapper 10 to the selected pipe (not shown). The strap 20 has a free end 24 secured by a buckle 22 on the housing 12. The strap 20 could also be any flexible material such as a chain, wire, web, net or ribbon. To use the invention, the plumber or service technician first must identify the conduit of interest. This is usually by physically locating or finding a source pipe that he knows is the same pipe or circuit he wants to find remotely. He then has to secure the tapper 10 to the selected conduit or pipe at the source location. The pipe or conduit can be made of any material which transmits vibrations such as copper, aluminum, steel, plastic, nylon, PVC, cast iron or the like.

The tapper 10 may also be used on cables such as wire or fiber optic. The cables can be stranded or solid in nature. Once again the requirement for performance is that the cable transmits mechanical vibration. Cables under tension usually transmit vibration better than cables which are untensioned, but even untensioned cables can be identified at remote locations using the tapper 10. If the cable is insulated, the tapper performs best if some insulation can be removed so that the reciprocating pin 16 is making vibrational contact with the inner cable material.

The tapper can also be used in a variety of other applications such as railroad work, air ducts, steel I-beam construction, bridge work, cable cars, ski trams, funicular train cables, underwater cable and conduit, space station conduit, aircraft conduit, airframes, high tension towers, high tension cable, telephone and power lines, underground conduit and cable, rescue systems in cave applications, gas lines, chemical plants, refineries, cargo ships and container vessels, tunnel systems,

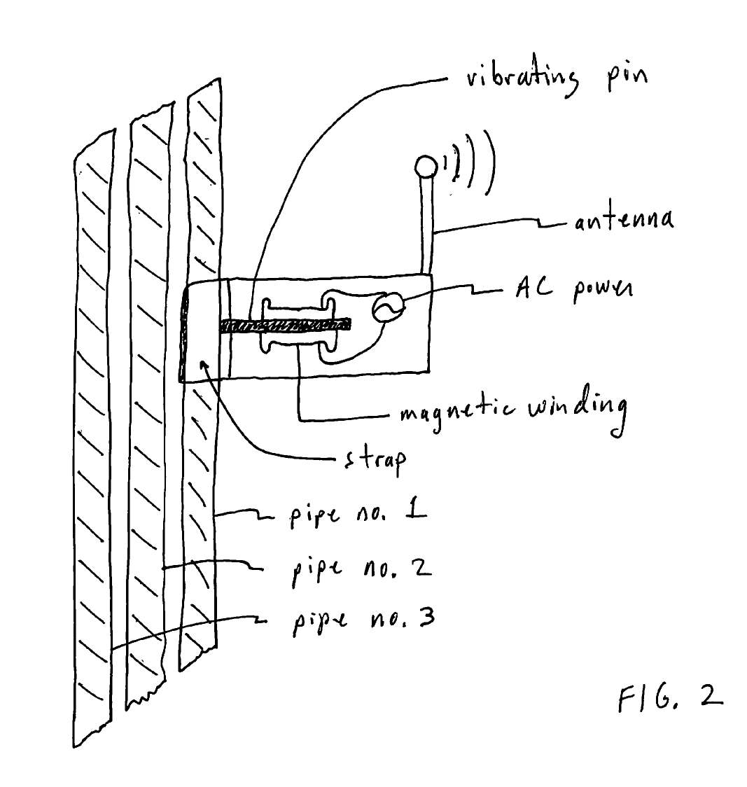

Now referring to FIG. 2 a pipe tapper is shown mounted to one of three pipes. The unit has an antenna for remote control so as to turn the unit ON or OFF or select other parameters such as vibrational speed or depth of stroke. In this embodiment the tapping pin is being driven by a solenoid which requires AC power to drive the magnetic windings.

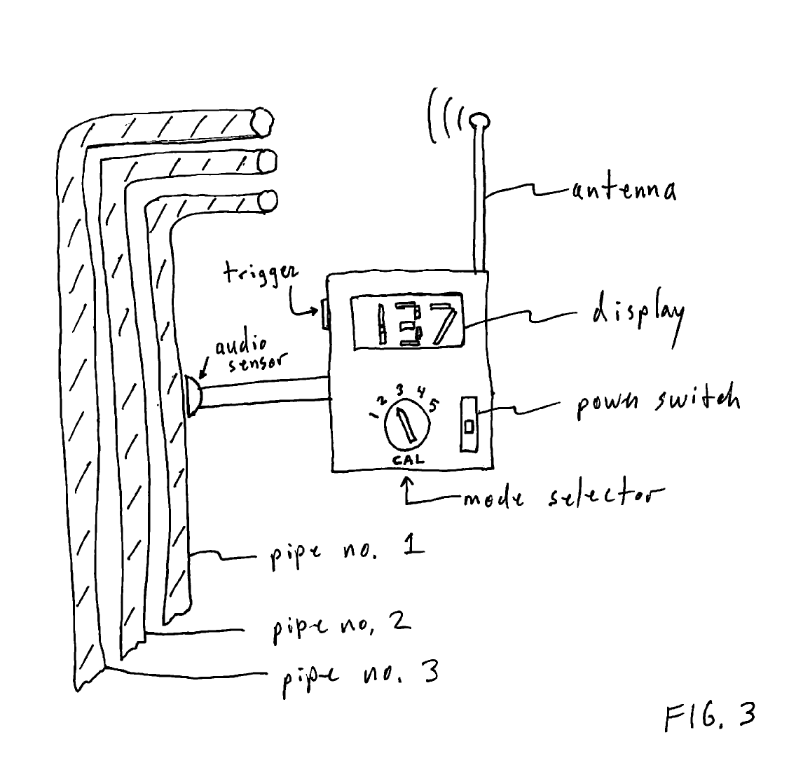

Now referring to FIG. 3 a remote control detector is shown. Once the technician has installed the Tapper (see FIG. 2) on the pipe of interest, he then moves to the remote location where he is trying to identify the correct pipe. The remote control unit in FIG. 3 controls the Tapper via RF as is known in the art. The remote control unit has an antenna for transmitting RF signals to the tapping unit in FIG. 2. A display can give the operation information such as signal strength of the vibrations received by the audio sensor. A calibration switch is used to vary the power at the tapping unit or change the sensitivity of the audio sensor. A power switch controls the remote detector and a trigger is used to tell the tapper to start tapping (compress trigger) or (release trigger) stop. An operator touches the audio/vibrational sensor to different pipes until he finds the pipe with the strongest vibratory signal.

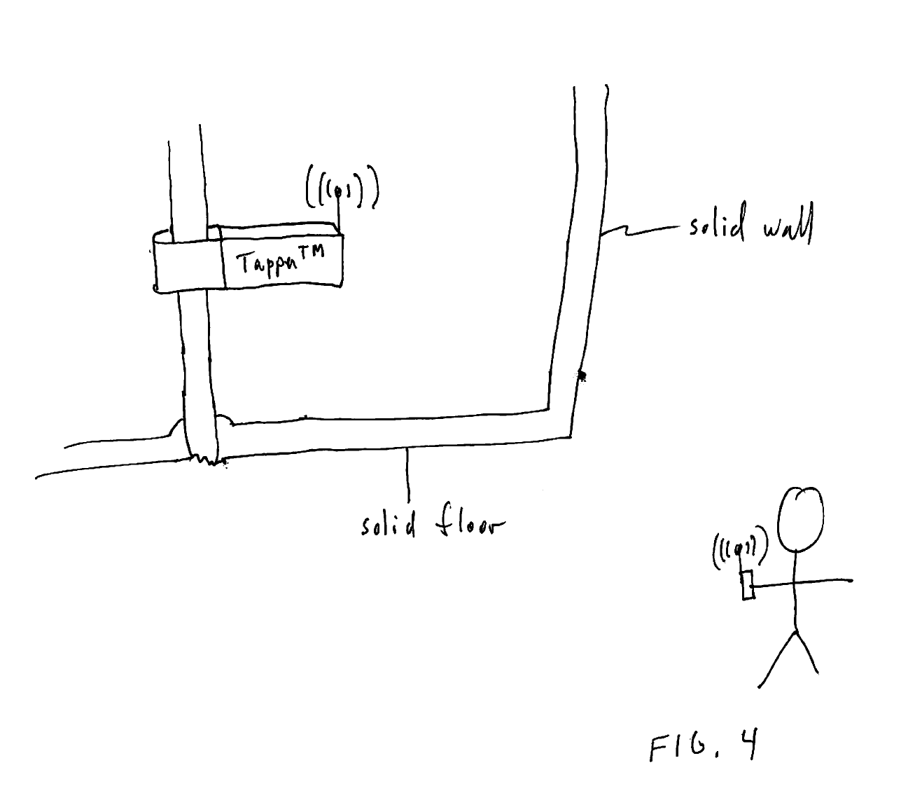

Now referring to FIG. 4 an operator is shown in a remote location controlling the tapper unit via RF signals through solid walls and floors. Thus the tool allows a one man operation of finding remote pipes.

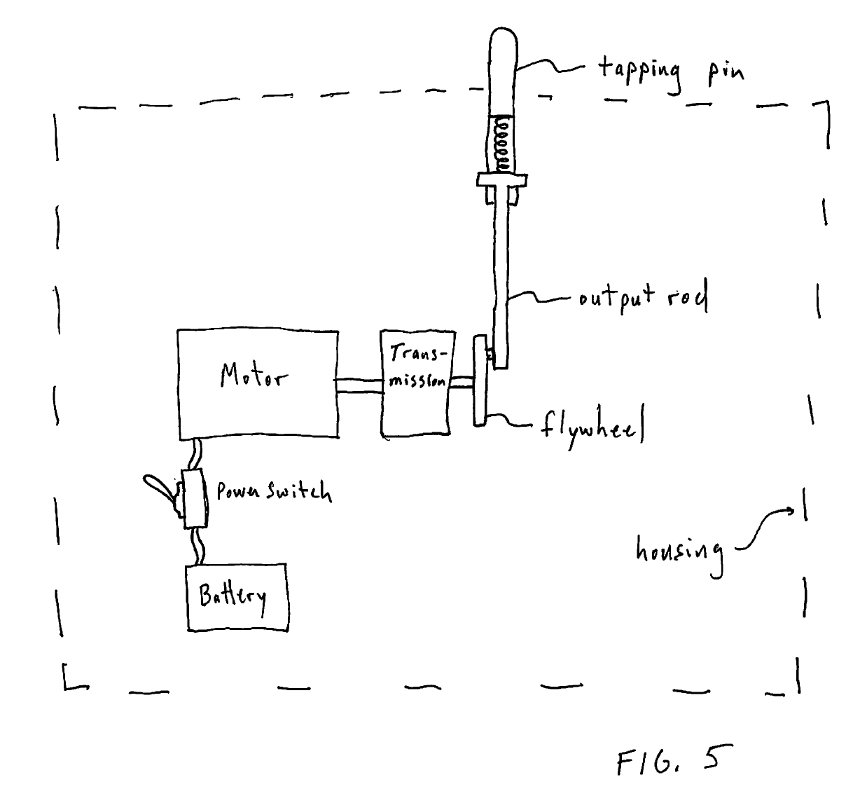

Now referring to FIG. 5 the internal power train of one embodiment of the invention is shown. A DC battery selectively powers a DC motor through an ON/OFF switch. The DC motor output axle is couple to a multispeed transmission controllable by the operator for different pipe conditions requiring different vibrational speeds. The output axle of the transmission is coupled to a fly wheel which drives an output rod in a reciprocating motion. The output rod is coupled to the tapping pin via a mechanical linkage.

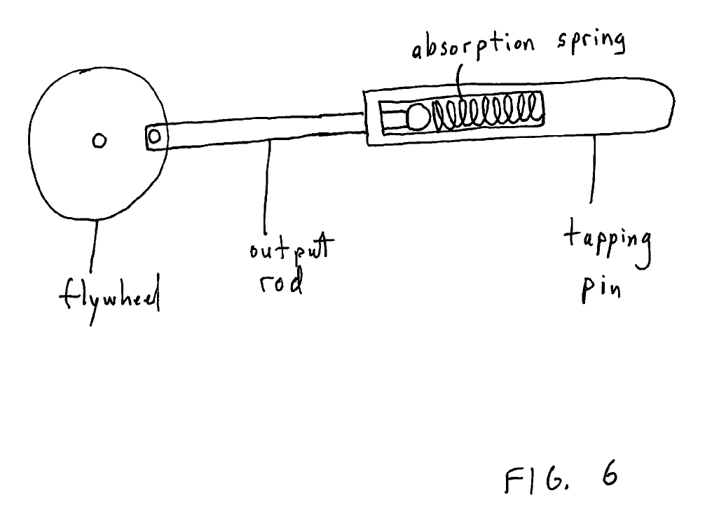

Now referring to FIG. 6, the mechanical linkage of FIG. 5 is shown in more detail. In particular it should be noted that the output rod is slidably coupled to the tapping pin so that the linkage is not rigid. The end of the output rod has a transverse pin which pushes against a spring captured in an internal slideway inside the tapping pin. This allows the rod to complete its full stroke even when the pin cannot travel any further due to contact with the solid pipe. Thus the tapping pin stroke is not a critical dimension in manufacture or operation.

The tip of the pin may be made from some elastic material such as rubber or deformable plastic. This feature is important so that the tapping does not cause any damage to the selected pipe.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

We claim:

1. A pipe or conduit locating tool for work by plumbers or other technicians who need to identify a specific known pipe at one location at another remote location where the pipe or conduit exists in and among a plurality of other pipes thus causing confusion, said tool comprising:
a housing including a motor for driving a reciprocating pin in and out of the housing into a space surrounded by a mounting strap;
said strap permanently secured on one side of the housing and removably secured on another side;
a power switch for turning on and off the motor;
whereby said housing is secured to a known pipe by said strap and said power switch is turned on causing said motor to drive said pin in an out of said housing, said pin coming into physical tapping contact with said pipe on each stroke and further causing a sound wave to travel down said pipe to a remote location where a worker can audibly detect which pipe is transmitting the sound.
